(19) United States
(12) Patent Application Publication
(10) Pub. No.: US 2012/0084016 A1
(43) Pub. Date: Apr. 5, 2012

(54) PORTABLE LASER-INDUCED BREAKDOWN SPECTROSCOPY SYSTEM WITH MODULARIZED REFERENCE DATA

(75) Inventor: Irl M. Davis, Portland, OR (US)

(73) Assignee: LASTEK, INC., Portland, OR (US)

(21) Appl. No.: 12/895,335

(22) Filed: Sep. 30, 2010

(51) Int. Cl. G06F 19/00; G01N 31/00

(52) U.S. Cl. 702/28

(57) ABSTRACT

A portable laser-induced breakdown spectroscopy (LIBS) system has a laser module, a spectrometer connected to the laser module, and an analysis sub-system connected to the spectrometer, the analysis sub-system having: a data module having at least one set of reference data for a particular material; a processor configured to access data from the spectrometer generated from a sample under test, and to compare the data from the spectrometer to the set of reference data; and a user interface through which the analysis sub-system provides a user with information about a presence, if any, of the particular material in the sample under test. A computer-controlled method of operating a laser-induced breakdown spectroscopy (LIBS) system includes receiving, at computer, an input from a detector, the input relating to a sample under test, generating a characteristic spectrum from the input, accessing reference data for a particular material, the reference data residing in a data module accessible by the computer, using the computer to compare the reference data to the characteristic spectrum, and presenting the result through a user interface.

### BACKGROUND

Laser-induced breakdown spectroscopy (LIBS) allows detection and measurement of elemental species. Typically, a laser beam becomes focused on a sample of interest (or sample under test) and the high instantaneous peak irradiance generates plasma or a spark at the surface. The species present in the sample turn into electronically excited atoms and ions. As the excited species decay, they emit radiation in a characteristic spectrum.

Light resulting from the material's settling from the spark is gathered and analyzed using a spectrometer and a detector. The resulting light spectrum emitted from the sample allows identification of the species present in it. The spectrometer produces a graph of the emitted spectrum that allows a user to determine the presence of a particular material or materials and its concentration.

Typically, the results have to be analyzed by a human who recognizes the trademark spectrum for a particular material and identify the material. Computers may also analyze the result, but generally require a sample that contains the material and its trademark spectrum for comparison and analysis.

LIBS systems have several advantages of other types of spectroscopy systems. LIBS systems rely upon the light spectrum rather than mass spectrum, allow the LIBS system to be deployed remotely from the analyzing computer. In industrial applications, this allows the laser module to deploy far from the computer, meaning that the laser may be mounted in a smokestack high above a manufacturing floor, but the computer can reside on the floor. Similarly, for toxic and/or dangerous environments such as nuclear reactors, the remote deployment allows for safe monitoring of conditions.

Another advantage of the LIBS system lies in its relative ease of sample preparation. One of the available alternatives to LIBS, laser-ablation inductively coupled plasma mass spectrometry (LA-ICPMS) requires laboratory conditions and careful sample preparation. LIBS does not have these requirements because of the nature of the light spectroscopy, instead of mass spectroscopy.

Another elemental analysis system involves x-ray fluorescence. In x-ray fluorescence, the material under test is identified by the light spectrum, similar to LIBS. However, instead of exposing the sample to a pulsed laser, the system bombards the sample under test with high-energy x-rays, gamma rays. However, x-ray fluorescence requires fairly extensive sample preparation and typically involves a large unit to produce the gamma rays used to excite the sample. LIBS does not suffer from these limitations.

Further, current LIBS systems generally have rather large dimensions as well. Making these systems portable and allowing the users to detect the levels of a particular material on site using the portable LIBS system will provide several advantages in its future development.

### BRIEF DESCRIPTION OF THE DRAWINGS

FIG. 1 shows an embodiment of a portable laser-induced breakdown spectroscopy (LIBS) system.

FIG. 2 shows another embodiment of a portable LIBS system.

FIG. 4 shows an embodiment of a memory usable with a portable LIBS system.

FIG. 4 shows a flowchart of an embodiment of a method of operating a portable LIBS system.

FIG. 5 shows a flowchart of an embodiment of a method of updating a portable LIBS system data module.

### DETAILED DESCRIPTION OF THE EMBODIMENTS

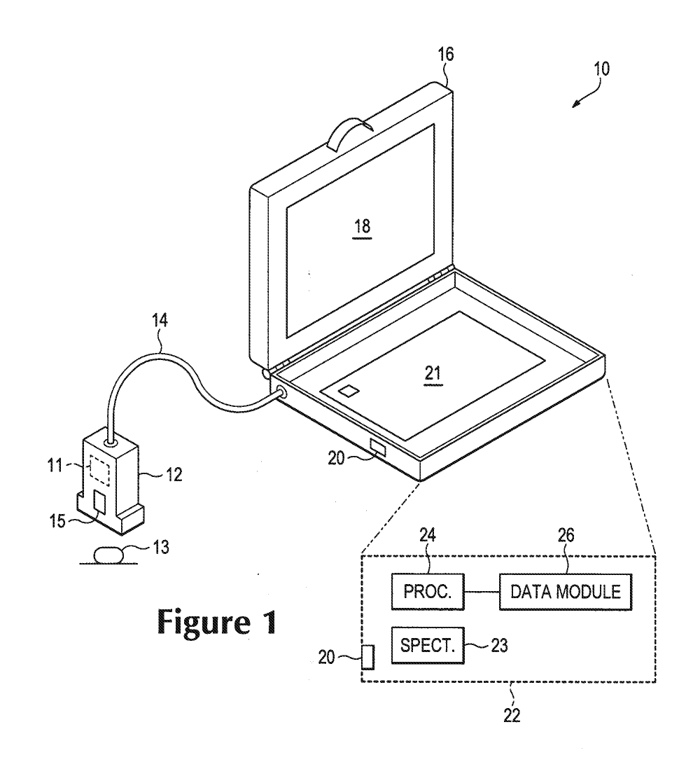

FIG. 1 shows an embodiment of a laser-induced breakdown spectroscopy (LIBS) system. In this embodiment, the system comprises a laser module 12 that the user can position over the sample under test/sample of interest 13. The laser module will typically include a detector 11 that will record the spectrum generated by the sample 13 when exposed to the laser 15.

One should note that any particular configuration and location of the various elements of this system is not intended to limit the scope of the claims. The laser, detector, spectrometer, processor, and data module may reside in one housing, multiple housing, etc. If they reside in multiple housings, the various components may be combined in many different ways. For example, the detector could reside with the laser, or it could reside in the analysis module. The spectrometer that generates the spectrum recorded by the detector may reside with the detector, the analysis module or neither.

Similarly, the analysis module 16 is shown as having a ‘briefcase’ form factor, connected to the laser module remotely. However, other form factors are of course possible. One possible form factor would be something that looks similar to a metal detector, discussed in more detail relative to 22. Another aspect of the form factor is that these units could be physically separated, with the analysis unit being at a base station and the laser module in a mobile, hand-held unit, where the two units communicate wirelessly.

The laser module 12 provides data to the analysis module 16. The analysis module 16 has a user interface 18, in this case a display but it could also take the form of a printer, and a user input device 21, in this case a keyboard. The analysis module will also include a ‘computing device’ 22 having at the very least a processor. The processor 24 may also function as a spectrometer, essentially a device that measures properties of light over a specific portion of the optical spectrum and produces a graph of the characteristic spectrum. The spectrometer may be more easily included as previously-manufactured spectrometer 23.

The computer 22 may also include a data module 26. The data module includes at least one set of reference data for a particular element. For example, if the LIBS system were analyzing a site for the presence of carbon, the user would select carbon as the particular material of interest and the reference data would be for carbon. The data module will be discussed in more detail with regard to FIG. 3. The computer may also include an interface or a port 20 that allows the computer to access a network for updates, such as a wireless network interface, or to access external memory devices, such as a USB port.

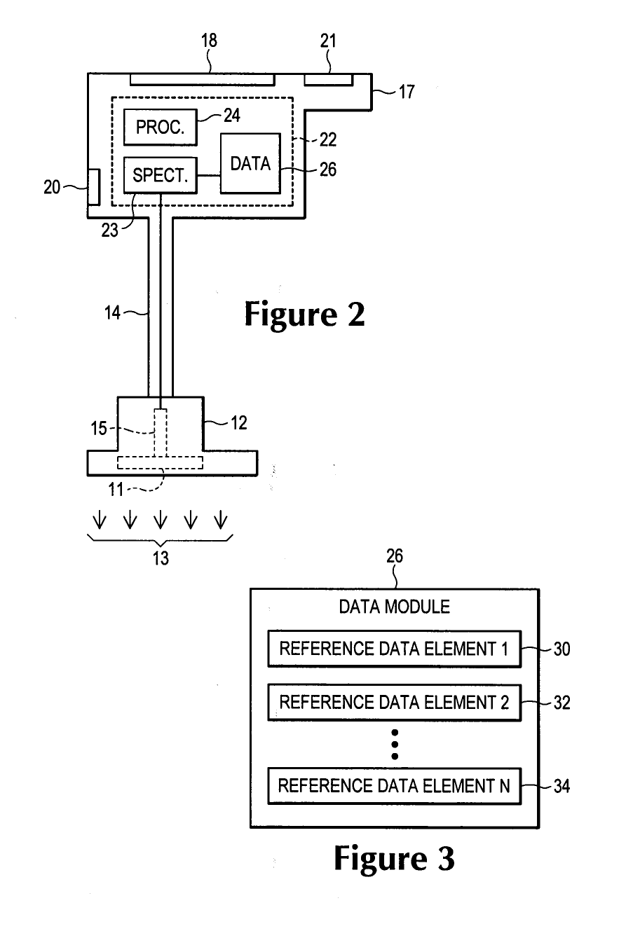

As mentioned above, the system in FIG. 1 merely shows on example of a LIBS system form factor, Another possible system form factor could be similar to a metal detector, shown in FIG. 2. In this embodiment, the laser module 12 would reside at the end of a shaft in which the connector cable 14 runs between the laser module and the computer 22. The user interface may reside at the top of the ‘handle’ unit with the keypad or other user input device 21. In this instance, the unit would have a handle or grip 17 that allows a user to move the device over the ground where analysis is desired. The LIBS technology, being non-contact and non-invasive, provides several apparent advantages in this embodiment.

As discussed above, the data module 26 contains the reference data for a particular element, shown in FIG. 3. This allows for an operator that may not have the required training to manually look at a spectral output of the spectrometer and be able to identify the element by is characteristic spectrum. For example, a worker may be inspecting a site for carbon contamination. The worker operates the LIBS system and rather than seeing a spectrum display typically seen on the display of a spectrometer, the system compares the spectrum generated by the spectrometer to the reference data and provides a textual output to the operator indicating the presence and level of carbon on the site.

The data module could also be used to store the individual samples as the worker moves around a given area. Combining the readings and analysis with mapping software would allow the user to generate a site profile and allow accurate identification of areas that require carbon sequestration and areas that do not.

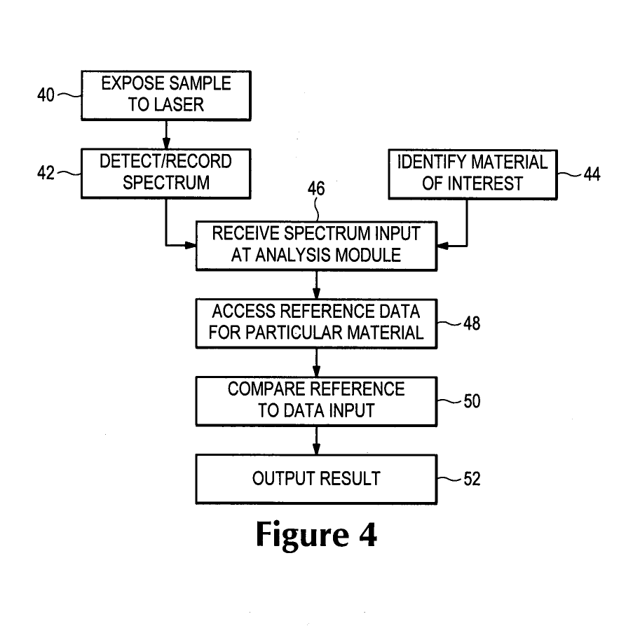

FIG. 4 shows an embodiment of a method of operating the LIBS system using the modularized data. Upon powering on the unit, or at some other point prior to or simultaneously with actually triggering the laser, the user identifies the particular material of interest for which the user is looking at 44. The user triggers the laser at 40 to expose the sample/site to the laser.

As the exposure to the laser causes the sample under test to become excited and emit its characteristic spectrum, the detector detects the light output and the spectrometer analyses it to generate the characteristic spectrum graph. The analysis module or the computing device within the analysis module, depending upon the system configuration, then receives the spectrum input at 46. The processor then accesses the data module and the reference data for that particular material at 48. The processor then compares the characteristic spectrum generated by the spectrometer with the reference data at 50 and produces a result that indicates the presence or absence of the particular material, and, if present, its concentration in the sample at 52.

Typically, in the interest of speed and portability, the data module and the reference data will be contained within the housing with the computer 22. However, in some embodiments, there may be an advantage to having several external memory modules, such as USB thumb drives, each with the reference data for a particular material. This would allow for more modularized data storage and may reduce the cost of the base unit. Entities using the LIBS system may only need the data for one particular material and having a larger memory to store multiple sets of reference data may not be desirable, while allowing entities that want multiple sets of reference data to have that ability. Each set could be on its own thumb drive or memory card.

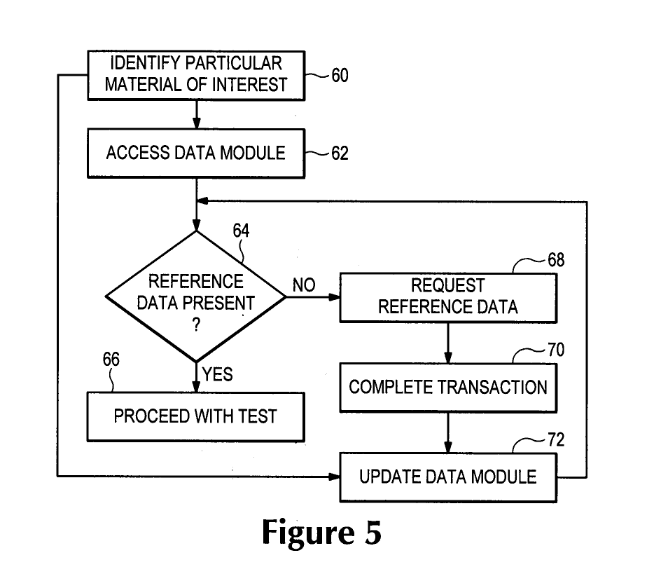

In either case, the system will generally have one set of reference data of interest, while allowing users to purchase other modules for other materials. FIG. 5 shows an embodiment of a process to allow users to purchase further reference data sets. At 60, the user identifies a particular material of interest in one embodiment. The system then accesses the data module at 62 and makes the determination at 64 whether or not the data module has the reference data for that material. If the reference data is there, the unit proceeds with the test. Note that the process of updating the data module may not occur commensurate with a test, in which case the testing process 66 is optional.

Alternatively, the user may already be aware that the data module does not have the reference data of interest, in which case the process proceeds immediately to 68. At 68, the user or the unit requests the reference data. This may occur on a pay-as-you-go basis, in which the user purchases each reference module as needed, or even on a subscription basis, in which the user purchases a periodic subscription that allows a certain number of material reference data sets to be accessed.

At 70, the transaction completes. This may take the form of an e-commerce type transaction, in which the user pays for the new module and then downloads it. Alternatively, the user may receive a memory device via delivery that includes the new reference data, etc. Once the reference data is received, the user can update the data module at 72 to include the new reference data set.

For the embodiments where the reference data sets reside external to the LIBS system, the update to the data module may involve some sort of update to the user interface to show the new material reference data set as an option to the user. This would allow the user to select the desired material of interest from all of the resident data sets.

In this manner, a portable LIBS system has the ability to update the reference data to include new materials of interest. Thus, although there has been described to this point a particular embodiment for a laser-induced breakdown spectroscopy system with modularized data, it is not intended that such specific references be considered as limitations upon the scope of this invention except in-so-far as set forth in the following claims.

What is claimed is:

1. A portable laser-induced breakdown spectroscopy (LIBS) system, comprising
a laser module;
a spectrometer connected to the laser module; and
an analysis sub-system connected to the spectrometer, the analysis sub-system comprising:
a data module having at least one set of reference data for a particular material;
a processor configured to access data from the spectrometer generated from a sample under test, and to compare the data from the spectrometer to the set of reference data; and
a user interface through which the analysis sub-system provides a user with information about a presence, if any, of the particular material in the sample under test.

2. The portable LIBS system of claim 1, wherein the laser module resides in a unit separate from the spectrometer and the analysis sub-system.

3. The portable LIBS system of claim 1, wherein the laser module, the spectrometer and the analysis sub-system are integrated into the same housing.

4. The portable LIBS system of claim 1, wherein the laser module and the computer have wireless interfaces configured to communicate with each other.

5. The portable LIBS system of claim 1, further comprising a data port to allow the unit to connect to a network.

6. The portable LIBS system of claim 1, further comprising a peripheral port configured to allow connection to external memory devices.

7. A computer-controlled method of operating a laser-induced breakdown spectroscopy (LIBS) system, comprising:
receiving, at computer, an input from a detector, the input relating to a sample under test;
generating a characteristic spectrum from the input;
accessing reference data for a particular material, the reference data residing in a data module accessible by the computer;
using the computer to compare the reference data to the characteristic spectrum; and
presenting the result through a user interface.

8. The computer-controlled method of claim 7, wherein receiving the input comprises receiving the input through a cable connected between a laser module and the computer.

9. The computer-controlled method of claim 7, wherein receiving the input comprises receiving the input from a detector located in the same housing as the computer.

10. The computer-controlled method of claim 7, wherein receiving the input comprise receiving the input wirelessly.

11. The computer-controlled method of claim 7, wherein presenting the result through a user interface comprises displaying the result on a display.

12. The computer-controlled method of claim 7, further comprising storing the result in the data module.

13. A computer-controlled method of updating a data module in a laser-induced breakdown spectroscopy system, the method comprising:
receiving, at a computer, a request for reference data for a particular material;
using the computer to access a data module to determine if the reference data for the particular material resides in the data module;
requesting reference data for the particular material if the data module does not include the reference data; and
updating the data module to include the reference data for the particular material.

14. The method of claim 13, wherein requesting reference data for the particular material comprises accessing a data site on a network.

15. The method of claim 13, wherein updating the data module comprises downloading the reference data into the module.

16. The method of claim 13, wherein updating the data module comprises loading the reference data from an external memory.
